(19) United States
(12) Patent Application Publication
(10) Pub. No.: US 2021/0362462 A1
(43) Pub. Date: Nov. 25, 2021

(54) DECORATIVE SHEET

(71) Applicant: Toppan Printing Co., Ltd., Tokyo (JP)

(72) Inventor: Mamiko SANO, Tokyo (JP)

(73) Assignee: Toppan Printing Co., Ltd., Tokyo (JP)

(21) Appl. No.: 17/397,044

(22) Filed: Aug. 9, 2021

Related U.S. Application Data
(63) Continuation of application No. PCT/JP2020/017211, filed on Apr. 21, 2020.

(30) Foreign Application Priority Data
Apr. 23, 2019 (JP) 2019-081929

(51) Int. Cl. B32B 3/30; B32B 27/32; B32B 27/08; B32B 27/30

(52) U.S. Cl. CPC B32B 3/30; B32B 27/32; B32B 27/08; B32B 27/302; B32B 2255/10; B32B 2605/003; B32B 2255/26; B32B 2307/732; B32B 2307/406; B32B 2250/246; B32B 2250/03; B32B 2307/412

(57) ABSTRACT

A decorative sheet comprises a transparent resin layer containing a polyolefin-based resin, and a surface protective layer containing a thermosetting resin and provided on a front surface side of the transparent resin layer. Further, an uneven pattern is provided on a front surface of the surface protective layer. A percentage of a surface waviness of the decorative sheet after molding to a surface waviness of the decorative sheet before molding, which is defined as a residual embossing ratio, is 30% or more; and an absolute value of a difference between a gloss of a surface of the decorative sheet before molding and a gloss of the surface of the decorative sheet after molding, which is defined as a gloss difference, is less than 5%.

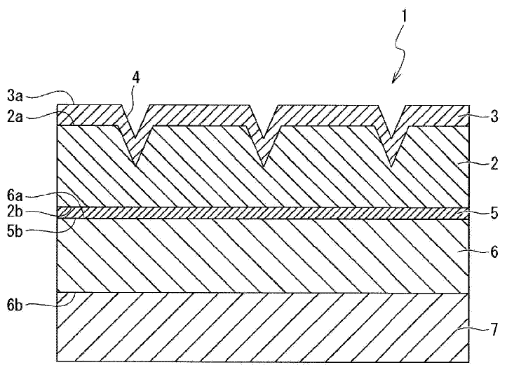

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Patent Application No. PCT/JP2020/017211, filed on Apr. 21, 2020, which is based upon and claims the benefit of priority to Japanese Patent Application No. 2019-081929, filed on Apr. 23, 2019; the disclosures of which are incorporated herein by reference in their entireties.

### TECHNICAL FIELD

The present invention relates to a decorative sheet.

### BACKGROUND

Conventionally, decorative molded products in which decorative sheets are laminated on the surface of resin molded articles have been widely used for interior and exterior materials of vehicles and interior materials of construction materials in order to impart design to the resin molded articles. Thermoplastic resins, such as polymethyl methacrylate (PMMA) resin, are generally used as the materials of such decorative sheets for easy thermal molding (see, for example, PTL 1).

[Citation List] [Patent Literature] PTL 1: JP 3998953 B

### SUMMARY OF THE INVENTION

### Technical Problem

However, if a resin sheet of a thermoplastic resin having excellent formability, such as PMMA resin, is used as the decorative sheet disclosed in PTL 1, there is a possibility that an uneven pattern or a matte texture applied to the surface of the decorative sheet may be lost due to heat and pressure during molding. In particular, when an injection molding method is employed as the molding method, the shape inside the mold is transferred to the surface of the decorative sheet. Accordingly, in order to apply an uneven pattern or a satin finish to the surface of a decorative molded product, it is necessary to prepare a special mold to which the uneven pattern or the satin finish is previously applied. Such decorative sheets are also required to have improved chemical resistance.

The present invention was made in view of the above problems, and an object of the present invention is to provide a decorative sheet that can maintain an uneven pattern and a matte appearance on the sheet surface even after molding, and that has improved or excellent formability and chemical resistance.

### Solution to Problem

In order to achieve the above object, a summary of an embodiment of the present invention is a decorative sheet comprising (a) a transparent resin layer containing a polyolefin based resin, and (b) a surface protective layer containing a thermosetting resin and provided on a front surface side of the transparent resin layer, (c) an uneven pattern being provided on a front surface of the surface protective layer, wherein (d) a percentage of a surface waviness of the decorative sheet after molding to a surface waviness of the decorative sheet before molding, which is defined as a residual embossing ratio, is 30% or more; and an absolute value of a difference between a gloss of a surface of the decorative sheet before molding and a gloss of the surface of the decorative sheet after molding, which is defined as a gloss difference, is less than 5%.

### Advantageous Effects of the Invention

According to one embodiment of the present invention, it is possible to provide a decorative sheet that can maintain an uneven pattern and a matte texture on the surface of the decorative sheet even after molding, and that has improved or excellent formability and chemical resistance.

### BRIEF DESCRIPTION OF THE DRAWINGS

The FIGURE is a cross-sectional view showing a decorative sheet according to an embodiment of the present invention.

### DETAILED DESCRIPTION

Embodiments of the present invention of will be described below with reference to the drawings. In the following description of the drawings to be referred, components or functions identical with or similar to each other are given the same or similar reference signs, unless there is a reason not to. It should be noted that the drawings are only schematically illustrated, and thus the relationship between thickness and two-dimensional size of the components, and the thickness ratio between the layers, are not to scale. Therefore, specific thicknesses and dimensions should be understood in view of the following description. As a matter of course, dimensional relationships or ratios may be different between the drawings.

Further, the embodiments described below are merely examples of configurations for embodying the technical idea of the present invention. The technical idea of the present invention does not limit the materials, shapes, structures, arrangements, and the like of the components to those described below. The technical idea of the present invention can be modified variously within the technical scope defined by the claims. The present invention is not limited to the following embodiments within the scope not departing from the spirit of the present invention.

In any group of successive numerical value ranges described in the present specification, the upper limit value or lower limit value of one numerical value range may be replaced with the upper limit value or lower limit value of another numerical value range. In the numerical value ranges described in the present specification, the upper limit values or lower limit values of the numerical value ranges may be replaced with values shown in examples. The configuration according to a certain embodiment may be applied to other embodiments.

Hereinafter, a decorative sheet according to an embodiment of the present invention will be described with reference to the drawing. The present invention is not limited to the following embodiments. Design modifications can be made on the basis of the knowledge of a person skilled in the art, and such modifications are also included in the scope of the present invention. In addition, the drawing is exaggerated as appropriate to facilitate understanding.

(Configuration)

As shown in the FIGURE, the decorative sheet 1 according to an embodiment of the present invention comprises a transparent resin layer 2, and a surface protective layer 3 provided on a front surface 2a side of the transparent resin layer 2. Further, an uneven pattern 4 is provided on a front surface 3a of the surface protective layer 3.

(Transparent Resin Layer)

As the material of the transparent resin layer 2, for example, a polyolefin-based resin can be used in terms of processability, economic efficiency, and the like. The polyolefin-based resin may be, for example, a polypropylene based resin, a polyethylene-based resin, or the like. The most suitable polyolefin-based resins for general use are polypropylene based resins, that is, a homopolymer or copolymer containing propylene as the main component. For example, a homopolypropylene resin, a random polypropylene resin, a block polypropylene resin, or the like may be used alone or appropriately mixed, and resins obtained by appropriately further mixing atactic polypropylene with these resins may be used. In addition, a copolymer containing an olefin-based monomer other than propylene, such as an α-olefin other than propylene having 2 to 20 carbon atoms and having a polypropylene crystal portion can be used, and a propylene-α-olefin copolymer containing 15 mol % or more of one or more types of comonomers among ethylene, 1-butene, 4-methyl-1-pentene, 1-hexene, and 1-octene can be preferably used. Also, a modifier that is typically used for softening polypropylene-based resins, such as low-density polyethylene, an ethylene-α-olefin copolymer, ethylene-propylene copolymer rubber, ethylene-propylene-non-conjugated diene copolymer rubber, a styrene-butadiene copolymer, or a hydrogenated product thereof, can be added as appropriate.

Moreover, the thickness of the transparent resin layer 2 is preferably 50 μm or more and 144 μm or less.

(Surface Protective Layer)

The surface protective layer 3 is a layer for protecting the surface of the decorative sheet 1. The surface protective layer 3 is made of, for example, a thermosetting resin. Examples of thermosetting resins that can be used include acrylic urethane-based resins and fluororesins. Examples of acrylic urethane-based resins that can be used include a reaction product obtained by using an acrylic polyol compound as a main agent, and an isocyanate compound as a curing agent. Moreover, an ionizing radiation curable resin may be contained as long as it does not impair the formability of the present invention. Examples of ionizing radiation curable resins that can be used include a composition containing at least one of a prepolymer, oligomer, or monomer having a polymerizable unsaturated bond such as a (meth) acryloyl group, which has the property of undergoing a crosslinking reaction upon irradiation with ionizing radiation. Further, examples of the ionizing radiation that can be used include an electron beam and ultraviolet light. Moreover, examples of fluororesins that can be used include polyvinylidene fluoride, tetrafluoroethylene resins, tetrafluoroethylene-perfluoroalkoxy vinyl ether copolymers, tetrafluoroethylene-hexafluoropropylene copolymers, polychlorotrifluoroethylene, tetrafluoroethylene-ethylene copolymers, chlorotrifluoroethylene-ethylene copolymers, and polyvinyl fluoride (PVF). In particular, it is most desirable to use polyvinylidene fluoride as the fluororesin, in terms of chemical resistance.

(Uneven Pattern)

The uneven pattern 4 is a pattern for imparting a three-dimensional design to the decorative sheet 1. The uneven pattern 4 is not particularly limited, and the same patterns as those used for the surface protective layer in a conventional decorative sheet can be used. Examples of patterns that can be used include wood grain vessel patterns, stone grain patterns, cloth fiber patterns, abstract patterns, Japanese paper patterns, suede patterns, leather patterns, and pear-skin patterns. The uneven pattern 4 can be formed, for example, by a doubling embossing method, an extrusion lamination simultaneous embossing method, or the like.

(Other Layers)

In addition to the transparent resin layer 2 and the surface protective layer 3, the decorative sheet 1 may appropriately comprise, for example, a pattern layer 5, a solid layer 6, and a substrate layer 7, as with conventional decorative sheets. The pattern layer 5 is provided on a rear surface 2b side of the transparent resin layer 2. The solid layer 6 is provided on a rear surface 5b side of the pattern layer 5. The substrate layer 7 is provided on a rear surface 6b side of the solid layer 6. In the FIGURE, the pattern layer 5, the transparent resin layer 2, and the surface protective layer 3 are laminated in this order on a front surface 6a of the solid layer 6. Further, the substrate layer 7 is laminated on the rear surface 6b of the solid layer 6.

(Pattern Layer)

The pattern layer 5 is a layer that is provided as necessary to impart design to the decorative sheet 1 by a pattern. The pattern layer 5 is formed using printing ink, a coating agent, or the like. The printing ink or the like is not particularly limited, and the same printing inks as those used for the pattern layer in a conventional decorative sheet can be used. For example, an acrylic ink can be used as the printing ink or the like. Examples of acrylic inks that can be used include two-component curable urethane resin-based inks obtained by mixing an acrylic polyol-based vehicle with an isocyanate curing agent. Furthermore, examples of printing methods that can be used include gravure printing and offset printing. The pattern is not particularly limited, and the same patterns as those used for the pattern layer in a conventional decorative sheet can be used. For example, a pattern synchronized with the uneven pattern 4 can be used. Specific examples include wood grain patterns, stone grain patterns, cloth fiber patterns, cork patterns, abstract patterns, geometric patterns, and the like.

(Solid Layer)

The solid layer 6 is a layer that is provided as necessary to improve the designability of the pattern of the pattern layer 5. A colored thermoplastic resin can be used as the material of the solid layer 6.

(Substrate Layer)

The substrate layer 7 is a layer that is provided as necessary to serve as the base of the decorative sheet 1. Examples the material of the substrate layer 7 that can be used include those containing at least one resin selected from a copolymer synthetic resin of acrylonitrile, butadiene, and styrene (ABS resin), a polyester resin, a polycarbonate (PC) resin, a polypropylene (PP) resin, a mixed resin of a PP resin and a PE resin (PW resin), and a PMMA resin. Examples of ABS resins that can be used include a polymer blend-type material containing a styrene-acrylonitrile copolymer and nitrile rubber (NBR), and a graft-type material obtained by graft copolymerizing styrene and acrylonitrile in the presence of polybutadiene rubber (BR) or styrene-butadiene rubber (SBR) latex. Further, the content ratio of butadiene is preferably 20 mass % or more and 50 mass % or less, for example, from the viewpoint of ease of stretching of the ABS resin. In addition, examples of polyesters that can be used include polytrimethylene terephthalate, polybutylene terephthalate, polyethylene naphthalate, and polybutylene naphthalate.

(Residual Embossing Ratio)

In the decorative sheet 1 according to the present embodiment, as shown in the following formula (1), the percentage of the surface waviness of the decorative sheet 1 after molding with respect to the surface waviness of the decorative sheet 1 before molding (hereinafter referred to as “residual embossing ratio”) is 30% or more. Further, the residual embossing ratio is preferably 40% or more, and more preferably 50% or more. The measurement of surface waviness is carried out using a contact-type surface roughness tester (SJ-410, produced by Mitutoyo Corporation).

Residual embossing ratio [%]=surface waviness after molding/surface waviness before molding×100≥30% (1)

Here, “surface waviness” is an amount using arithmetic average waviness Wa as a parameter.

(Gloss Difference)

In the decorative sheet 1 according to the present embodiment, as shown in the following formula (2), the absolute value of the difference between the gloss of the surface of the decorative sheet before molding and the gloss of the surface of the decorative sheet after molding (hereinafter referred to as “gloss difference”) is less than 5%. Further, the gloss difference is preferably less than 3%, and more preferably less than 1%. The measurement of gloss is carried out using a glossmeter with an incident angle of 60°.

Gloss difference=|(gloss before molding)−(gloss after molding)|<5% (2)

(Method for Producing Decorative Molded Product)

By laminating the decorative sheet 1 according to the present embodiment on a resin molded product, a decorative molded product decorated with the resin molded product can be produced. Examples of the method for producing a decorative molded product that can be used include an injection molding method and a TOM (three dimension overlay method) molding method. For example, the injection molding method is a method for producing a decorative molded product in such a manner that using a preforming mold, the decorative sheet 1 is heated to 130° C. and preformed by air pressure forming, then the preformed decorative sheet 1 is trimmed, the trimmed decorative sheet 1 is fitted into an injection molding die, and a resin is injected into the back side of the decorative sheet 1 to integrate the resin (resin molded article) and the decorative sheet 1. Further, the TOM molding method is a method for producing a decorative molded product in such a manner that a resin molded article to be decorated, the decorative sheet 1, and a receiving jig are set in a case, after a vacuum is formed, the temperature of the decorative sheet 1 is raised to a set value by a heater, and after the temperature rise is completed, molding is performed by applying a pressure of 0.3 MPa, and after then cooling in the air, the decorative molded product is removed from the receiving jig of the mold.

Since the injection molding method is a method of integrating the decorative sheet 1 with a resin by injecting the resin, the resulting molded product (decorative molded product) consists of the resin. On the other hand, since the TOM molding method is a secondary decoration method that decorates the base material (resin molded article), it can decorate metals and other materials in addition to resins, and the resulting molded product (decorative molded product) can be composed of materials other than the resin. Moreover, in the TOM molding method, the mold does not contact the surface of the decorative sheet 1, and thus this method is less likely to lose the surface texture than the injection molding method.

As described above, the decorative sheet 1 according to the present embodiment comprises a transparent resin layer 2 containing a polyolefin-based resin, and a surface protective layer 3 containing a thermosetting resin and provided on a front surface 2a side of the transparent resin layer 2. Further, an uneven pattern 4 is provided on a front surface 3a of the surface protective layer 3. Then, the residual embossing ratio is 30% or more, which is the percentage of the surface waviness of the decorative sheet 1 after molding with respect to the surface waviness of the decorative sheet 1 before molding, and the gloss difference is less than 5%, which is the absolute value of the difference between the gloss of the surface of the decorative sheet 1 before molding and the gloss of the surface of the decorative sheet 1 after molding. Therefore, it is possible to provide a decorative sheet 1 that can maintain an uneven pattern and a matte texture on the surface of the decorative sheet even after molding, and that has excellent formability and chemical resistance.

Further, in the decorative sheet 1 according to the present embodiment, the polyolefin-based resin is preferably a polypropylene based resin. Processability and cost-effectiveness can be thereby improved.

Further, in the decorative sheet 1 according to the present embodiment, the thermosetting resin is preferably a fluororesin. Chemical resistance can be thereby further improved.

Further, in the decorative sheet 1 according to the present embodiment, a pattern layer 5 is provided on a rear surface 2b side of the transparent resin layer 2. Therefore, the pattern can impart designability to the decorative sheet 1.

Further, in the decorative sheet 1 according to the present embodiment, a substrate layer 7 is provided on the rear surface 2b side of the transparent resin layer 2. Therefore, the strength of the decorative sheet 1 can be further improved.

Further, in the decorative sheet 1 according to the present embodiment, the substrate layer 7 contains at least one resin selected from a copolymer synthetic resin of acrylonitrile, butadiene, and styrene (ABS resin), a polyester resin, a polycarbonate resin, a polypropylene resin, a PW resin, and a PMMA resin. Therefore, processability and economic efficiency can be improved.

### EXAMPLES

Hereinafter, Examples and Comparative Examples of the decorative sheet 1 according to the present embodiment will be described. Note that the present invention is not limited to the Examples described below.

### Example 1

First, a polypropylene film (produced by Riken Technos Corporation) was prepared as a solid layer 6. The thickness of the polypropylene film was 60 μm. Then, a pattern layer 5 was formed by gravure printing on one surface of the polypropylene film. Then, clear polypropylene was melted and formed into a film with a T-die on the surface of the pattern layer 5, and cooled and solidified by a cooling roll with an uneven embossed shape, thereby laminating a transparent resin layer 2 to which an uneven pattern 4 was transferred. Then, an acrylic urethane resin was applied to the surface of the transparent resin layer 2 to which the uneven pattern 4 was transferred, thereby forming a surface protective layer 3. The coating amount of the acrylic urethane resin was 6 g/m². Furthermore, the thickness of the surface protective layer 3 was 75 μm. Then, the other surface of the polypropylene film was bonded together with an ABS resin film as a substrate layer 7. The thickness of the ABS resin film was 300 μm. Thus, the decorative sheet 1 of Example 1 was prepared.

Then, the produced decorative sheet 1 was laminated on a resin molded article by an injection molding method to thereby prepare the decorative molded product of Example 1, which was obtained by decorating the resin molded article.

### Example 2

In Example 2, a decorative molded product was prepared using a TOM molding method. Otherwise, the decorative sheet 1 and the decorative molded product were prepared using the same conditions as in Example 1.

### Example 3

In Example 3, a polyethylene (PE) resin was used as the transparent resin layer 2. Otherwise, the decorative sheet 1 and the decorative molded product were prepared using the same conditions as in Example 1.

### Example 4

In Example 4, a polyvinylidene fluoride (PVDF) resin was provided as the surface protective layer 3. Otherwise, the decorative sheet 1 and the decorative molded product were prepared using the same conditions as in Example 1.

### Comparative Example 1

In Comparative Example 1, a PMMA resin was used as the transparent resin layer 2. Otherwise, the decorative sheet 1 and the decorative molded product were prepared using the same conditions as in Example 1.

### Comparative Example 2

In Comparative Example 2, a UV curable resin was used as the surface protective layer 3. Otherwise, the decorative sheet 1 and the decorative molded product were prepared using the same conditions as in Example 1.

(Performance Evaluation)

The following performance evaluation was performed on the decorative sheets 1 and decorative molded products of Examples 1 to 4 and Comparative Examples 1 and 2.

(Formability Test)

In the formability test, the appearance of the decorative molded product was visually observed and evaluated. Then, cases where no whitening or cracking occurred were classified as a pass “excellent,” cases where whitening or cracking slightly occurred but was not a practical problem were classified as a pass “good,” and cases where obvious whitening or cracking occurred were classified as a failure “poor.”

(Residual Embossing Ratio Test)

In the residual embossing ratio test, the surface waviness of the decorative sheet 1 was measured before and after molding using a contact-type surface roughness tester (SJ-410, produced by Mitutoyo Corporation), and its change rate was calculated according to the formula (1) described above. Then, a score of 30% or more was classified as a pass “excellent,” a score of less than 30% and 20% or more was classified as a pass “good,” and a score of less than 20% was classified as a failure “poor.”

(Gloss Difference Test)

In the gloss difference test, the gloss of the surface of the decorative sheet 1 was measured before and after molding using a glossmeter with an incident angle of 60°, and its difference was calculated according to the formula (2) described above. Then, a change rate of less than 5% was classified as a pass “excellent,” and a change rate of 5% or more was classified as a failure “poor.”

(Stain Resistance Test)

In the stain resistance test, a sunscreen (Ultra Sheer SPF 100, produced by Neutrogena) was applied to the decorative sheet 1 and then allowed to stand in an environment at 80° C. for 24 hours, after which the sunscreen was wiped off with a dry cloth, and the state of the surface of the decorative sheet 1 was observed. Then, cases where there was no change in the appearance were classified as a pass “excellent,” cases where there was a slight change in the appearance but no problem in practical use were classified as a pass “good,” and cases where there was an obvious change in the appearance were classified as a failure “poor.”

(Evaluation Results)

The evaluation results are shown in Tables 1 and 2 below.

TABLE 1

| | Example 1 | Example 2 | Example 3 |
|---|---|---|---|
| Transparent | Polypropylene | Polypropylene | Polyethylene |
| resin layer | resin | resin | resin |
| Surface protective | Acrylic | Acrylic | Acrylic |
| layer | urethane | urethane | urethane |
| | resin | resin | resin |
| Molding method | Injection | TOM | Injection |
| | molding | molding | molding |
| | method | method | method |
| Formability | Excellent | Excellent | Excellent |
| Chemical resistance | Good | Good | Good |
| (sunscreen) | | | |
| Residual embossing | Excellent | Excellent | Good |
| ratio | | | |
| Gloss difference | Excellent | Excellent | Excellent |
| Overall evaluation | Excellent | Excellent | Excellent |

TABLE 2

| | | Comparative | Comparative |
|---|---|---|---|
| | Example 4 | Example 1 | Example 2 |
| Transparent | Polypropylene | PMMA resin | Polypropylene |
| resin layer | resin | | resin |
| Surface protective | PVD resin | Acrylic | UV curable |
| layer | | urethane | resin |
| | | resin | |
| Molding method | Injection | Injection | Injection |
| | molding | | |
| | method | | |
| Formability | Excellent | Excellent | Poor |
| Chemical resistance | Excellent | Excellent | Excellent |
| (sunscreen) | | | |
| Residual embossing | Excellent | Poor | Excellent |
| ratio | | | |
| Gloss difference | Excellent | Excellent | Excellent |
| Overall evaluation | Excellent | Poor | Poor |

As shown in Tables 1 and 2, the decorative sheets 1 of Examples 1 and 2 were classified as a pass “excellent” in the formability test, the residual embossing ratio test, and the gloss difference test. Since the surface protective layer 3 was an acrylic urethane resin, whose chemical resistance was lower than that of the PVDF resin used in Example 4, there was a slight change in the appearance in the chemical resistance test, but there were no problems in use, and these decorative sheets were classified as a pass “good.” Thus, these decorative sheets were classified as a pass “excellent” in the overall evaluation. Further, in the decorative sheet 1 of Example 3, the transparent resin layer 2 was a polyethylene resin, whose heat resistance was slightly lower than that of the polypropylene resin used in Example 1. Accordingly, in the residual embossing ratio test, there was a slight change in the appearance, but there were no problems in use, and this decorative sheet was classified as a pass “good.” Thus, this decorative sheet was classified as a pass “excellent” in the overall evaluation. Moreover, the decorative sheet 1 of Example 4 was classified as a pass “excellent” in all of the formability test, the chemical resistance test, the residual embossing ratio test, and the gloss difference test, because the surface protective layer 3 was a PVDF resin. Thus, this decorative sheet was classified as a pass “excellent” in the overall evaluation.

On the other hand, the decorative sheet 1 of Comparative Example 1 was classified as a pass “excellent” in the formability test, the chemical resistance test, and the gloss difference test, but was classified as a failure “poor” in the residual embossing ratio test because the transparent resin layer 2 was a PMMA resin, and the heat resistance was lower. Thus, this decorative sheet was classified as a failure “poor” in the overall evaluation. Further, the decorative sheet 1 of Comparative Example 2 was classified as a pass “excellent” in the chemical resistance test, the residual embossing ratio test, and the gloss difference test, but was classified as a failure “poor” in the formability test because the surface protective layer 3 was a UV curable resin, and the formability was lower. Thus, this decorative sheet was classified as a failure “poor” in the overall evaluation. These results confirmed that the decorative sheets 1 of Examples 1 to 4 could maintain an uneven pattern and a matte texture on the sheet surface even after molding, and had superior formability and chemical resistance, compared with the decorative sheets 1 of Comparative Examples 1 and 2.

### REFERENCE SIGNS LIST

1 . . . Decorative sheet; 2 . . . Transparent resin layer; 2a . . . Front surface of transparent resin layer; 2b . . . Rear surface of transparent resin layer; 3 . . . Surface protective layer; 3a . . . Front surface of surface protective layer; 4 . . . Uneven pattern; 5 . . . Pattern layer; 5b . . . Rear surface of pattern layer; 6 . . . Solid layer; 6a . . . Front surface of solid layer; 6b Rear surface of solid layer; 7 . . . Substrate layer.

What is claimed is:

1. A decorative sheet, comprising:
a transparent resin layer containing a polyolefin-based resin; and
a surface protective layer containing a thermosetting resin and provided on a front surface side of the transparent resin layer,
an uneven pattern being provided on a front surface of the surface protective layer, wherein:
a percentage of a surface waviness of the decorative sheet after molding to a surface waviness of the decorative sheet before molding, which is defined as a residual embossing ratio, is 30% or more; and
an absolute value of a difference between a gloss of a surface of the decorative sheet before molding and a gloss of the surface of the decorative sheet after molding, which is defined as a gloss difference, is less than 5%.

2. The decorative sheet of claim 1, wherein the polyolefin-based resin is a polypropylene based resin.

3. The decorative sheet of claim 1, wherein the thermosetting resin is a fluororesin.

4. The decorative sheet of claim 1, further comprising a pattern layer on a rear surface side of the transparent resin layer.

5. The decorative sheet of claim 1, further comprising a substrate layer on a rear surface side of the transparent resin layer.

6. The decorative sheet of claim 5, wherein the substrate layer contains at least one resin selected from a copolymer synthetic resin of acrylonitrile, butadiene, and styrene (ABS resin), a polyester resin, a polycarbonate resin, a polypropylene resin, a PW resin, and a PMMA resin.
